(19) United States
(12) Patent Application Publication
(10) Pub. No.: US 2011/0285615 A1
(43) Pub. Date: Nov. 24, 2011

(54) SELECTIVE BACKLIGHTING IN A SMART PORTABLE ELECTRONIC DEVICE

(76) Inventor: RAGHAVENDRA RAYADURGA, Bangalore (IN)

(21) Appl. No.: 12/782,505

(22) Filed: May 18, 2010

(51) Int. Cl. G09G 3/36

(52) U.S. Cl. 345/102

(57) ABSTRACT

A method for selectively controlling backlighting a display screen of a portable electronic device. The method includes executing code to display first content in the display screen and ascertaining at least a first portion of the display screen responsive to the first content, the first portion representing one of a backlight-enabled portion wherein backlighting is desirable and a backlight-nonenabled portion wherein backlighting is not desirable. The method includes selectively backlighting, using display control circuitry, the backlight-enabled portion of the display screen without backlighting the backlight-nonenabled portion while displaying the first content, both the backlight-enabled portion and the backlight nonenabled portion represent portions of the display screen for displaying different contents at different times on said display screen.

### FIELD OF THE INVENTION

The invention relates to methods and arrangements for selectively backlighting a portion or portions of a display screen to reduce energy usage.

### BACKGROUND

Smart portable electronic devices are ubiquitous nowadays. Generally speaking, a smart portable electronic device may execute any number of applications for telecommunication, entertainment, word processing, spreadsheets, database, and the like.

In a typical smart portable electronic device, such as a cellular phone, battery conservation is an important consideration. Generally speaking, one of the more heavy consumers of battery power in a smart portable electronic device is the display screen. When an application is executed, content is displayed on the LCD screen. The content may include text, image, video, etc. To assist the user in viewing the content, backlighting is often employed. Backlighting is also useful in daytime situations to allow the content to be more readily readable or viewable by the user.

In a typical prior art smart portable electronic device, the backlighting is generally applied in an on/off manner. In other words, backlighting is either on for the entire display screen or off for the entire display screen. For example, when the application is executing, backlighting is automatically enabled for the entire display screen, and when the smart device is idle, backlighting may be turned off for the entire display screen. As another example, the user may manually turn on backlighting for the entire display screen to enable the content to be more readily viewable.

Although backlighting helps the content to be more viewable to the user in certain situations, backlighting consumes a great deal of battery power. Since conservation of battery power is one of the more important considerations in smart portable electronic device design, engineers are constantly looking for ways to conserve battery power. The instant invention relates to an intelligent way to control backlighting in order to conserve battery power in a smart portable electronic device.

### SUMMARY

The invention relates, in one or more embodiments, at least to methods and arrangements for selectively backlighting a portion or portions of a display screen to reduce energy usage. In one or more embodiments, methods for selectively controlling backlighting a display screen of a portable electronic device are disclosed. The method includes executing code to display first content in the display screen and ascertaining at least a first portion of the display screen responsive to the first content, the first portion representing one of a backlight-enabled portion wherein backlighting is desirable and a backlight-nonenabled portion wherein backlighting is not desirable. The method includes selectively backlighting, using display control circuitry, the backlight-enabled portion of the display screen without backlighting the backlight-nonenabled portion while displaying the first content, both the backlight-enabled portion and the backlight nonenabled portion represent portions of the display screen for displaying different contents at different times on said display screen.

The above summary relates to only one of the many embodiments of the invention disclosed herein and is not intended to limit the scope of the invention, which is set forth is the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a typical display screen of a portable electronic device wherein content is displayed.

FIG. 2 shows, in accordance with an embodiment of the invention, a display screen of a portable electronic device wherein selective backlighting is applied.

FIG. 3 shows an example of a display screen in which there are two content areas to be selectively backlighted.

FIG. 4 shows, in accordance with an embodiment of the invention, the steps for selectively turning on or off backlighting on a display screen in selective areas of a display screen of a portable electronic device.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

Embodiments of the invention relates to services that interact with the display control hardware (such as the hardware controlling the liquid crystal display) to selectively turn on or off the backlighting of portions of the display screen. In an embodiment, an application informs the service of the particular area or areas of the screen in which backlighting should be turned on. Alternatively or additionally, in one or more embodiments, the application may inform the service which area or areas to turn off the backlighting. Backlighting control may be applied on an area-by-area basis, on a line-by-line basis, on a column-by-column basis, or even a pixel-by-pixel basis on the display screen of the smart portable electronic device.

The features and advantages of the invention may be better understood with reference to the figures and discussions that follow.

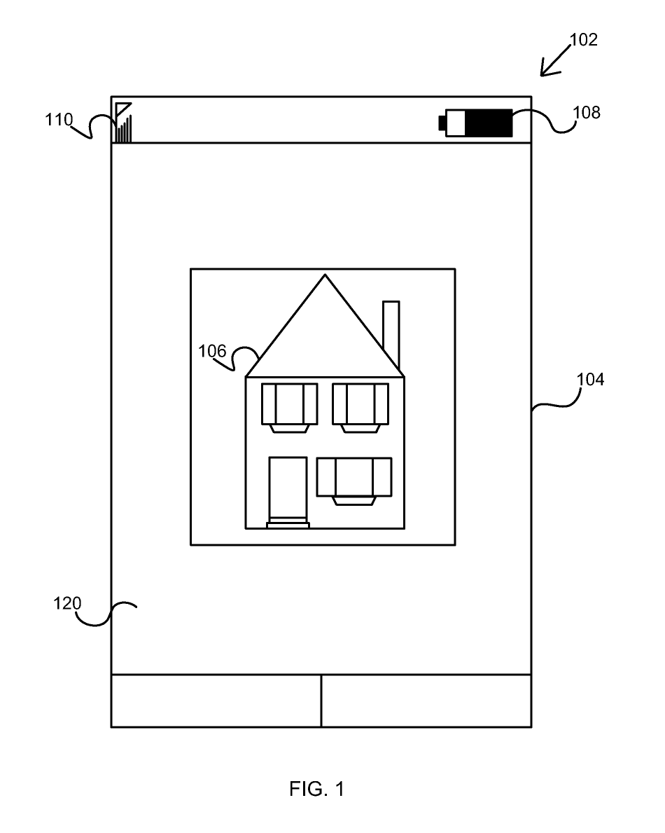

FIG. 1 shows a typical display screen of a smart portable electronic device wherein content is displayed. With reference to FIG. 1, LCD screen 102 includes a primary display area 104 within which content 106 is displayed under control of an application program, such as a photo viewer program. In the example of FIG. 1, there are icons 108 for displaying the amount of battery power remaining. Icon 110 displays the available signal to the portable electronic device, which relates, in the case of a cellular handset, to the ability of the antenna to receive cellular signal from the transmitter station of the cellular service provider. Other icons and display elements may also be present, depending on the application or applications being executed.

When the application program displays content 106, backlighting is turned on or off for the entire display screen as necessary. For example, in most modern portable electronic devices, backlighting is often turned on whenever content is displayed in the LCD display screen 102. Thus, backlighting is also enable for area 120, which displays no viewable content in the example FIG. 1.

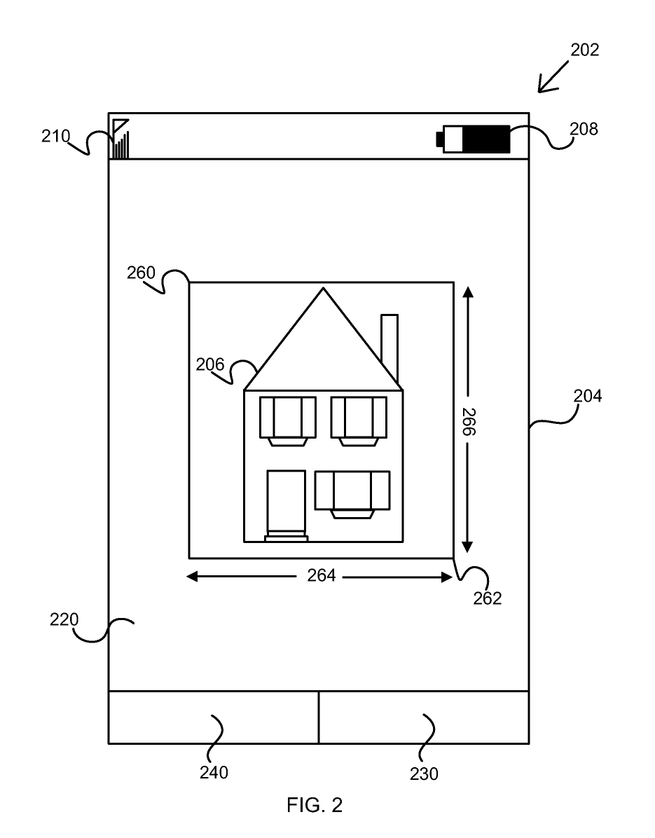

In accordance to an embodiment of the invention, the application program that displays content first informs a selective backlighting service of the area or areas to backlight or to inhibit backlighting. For example, with reference to FIG. 2, the application may inform the selective backlighting service to highlight only the pixels that overlap with content 206. Backlighting of area 220 is off to conserve battery power. In this manner, the display screen includes at least backlight-enabled area(s) where backlighting is enabled, and backlight-nonenabled area(s) where backlighting is not enabled. Note that both the backlight-enabled area(s) and the backlight-nonenabled areas represent areas for displaying different contents at different times on the display screen. For example, a portion of an area or an entire area that is backlight-nonenabled while the display screen displays one image may be backlight-enabled when the display screen displays another image. As another example, a portion of an area or an entire area that is backlight-enabled while the display screen displays a given image may be backlight-nonenabled when the display screen displays yet another image. Although not shown in the example of FIG. 2, backlighting may also be turned off for the screen area(s) that display signal strength icon 210 and battery power remaining icon 208. Likewise, the selective backlighting service may inform the LCD display control hardware to also turn backlighting off for status areas 230 and 240.

The backlighting instruction issued by the selective backlighting service may take different forms. For example, the selective backlighting service may specify the pixel coordinates for upper left corner 260, and lower right corner 262 (by treating the display as a matrix with the origin located at one of the corners). Alternatively, the selective backlighting service may specify a corner 260 and a width 264 and a length 266 of the shape to be backlighted. In the case of a more complex shape, the selective backlighting service may specify backlighting on a row-by-row basis (thus treating the display area as a matrix comprising of rows and columns of pixels). For certain rows, every pixel may be specified to be backlighted. For other rows, selective pixels in that row may have its backlighting turned on or off. In this manner, complex content areas may have their backlighting selectively controlled.

In one or more embodiments, selective backlighting may also be specified on a pixel-by-pixel basis. Although this form of specification requires more computational and I/O resources to communicate between the selective backlighting service and the LCD display control hardware, these forms of instruction may accommodate an almost infinite variety of shapes in content areas in which backlighting is either inhibited or enabled.

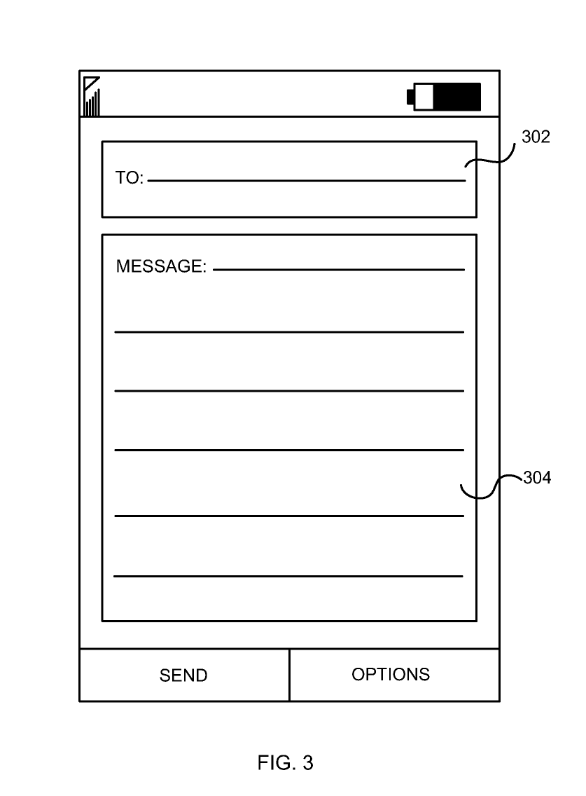

FIG. 3 shows an example of a display screen in which there are two content areas to be backlighted: content area 302 and content area 304. In the example of FIG. 3, content area 302 represents the address field of an email application, and content area 304 represents the message field of the email application. Again, the specification of the area to be backlighted may be specified by the corner coordinates of each display area to be backlighted, or by a specified corner and the width and height of each area to be backlighted. Alternatively or additionally, the area to be backlighted may be specified on a row-by-row basis for the entire display area, or may be specified pixel-by-pixel for the entire display area. As mentioned before, the selective backlighting service may specify an area or areas, along with instruction, to turn backlighting for that area or areas either on or off as desired.

With respect to implementation, the selective backlighting service may be incorporated into an application or may exist as a separate service communicable with the application via one or more appropriate APIs or application programming interfaces (e.g., to receive information from the application regarding the content to be displayed). The selective backlighting service then computes the area to backlight or to inhibit backlighting, and communicates those areas to the display control hardware in order to selectively control backlighting.

In one or more embodiments, the selective backlighting service can communicate with the display control hardware by a pre-specified color code. For example, any pixel that is associated with a pre-specified color code is understood to be backlighted (or not backlighted, depending on specific implementation). When the display control hardware receives the instruction to display the pixel, if the pre specified color code is encountered, the LCD display control hardware will interpret that color code to be an instruction for either turning on or off backlighting as desired.

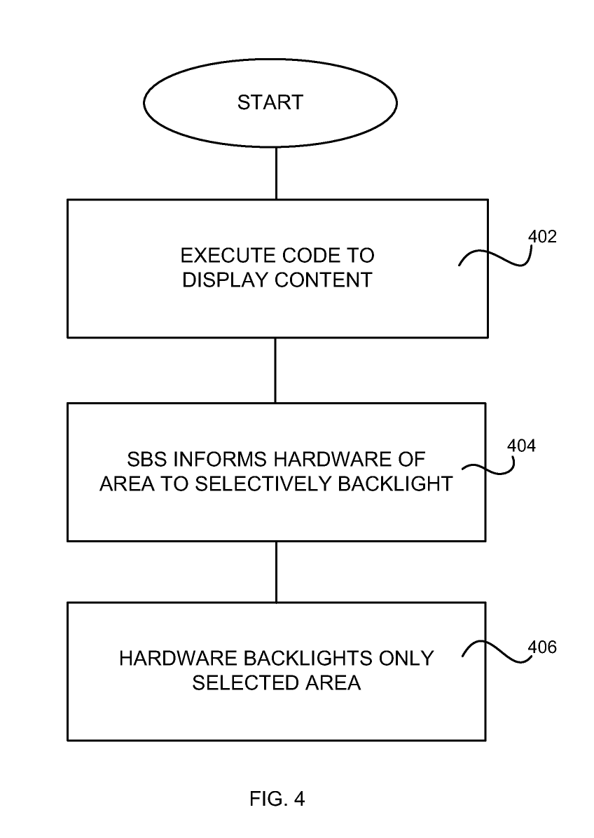

FIG. 4 shows, in accordance with an embodiment of the invention, the steps for selectively turning on or off backlighting on a display screen in selective areas of a display screen of a portable electronic device. In step 402, the application executes codes to display content on the display screen. In step 404, the selective backlighting service obtains information from the application program to compute the area or areas of the display screen in which backlighting is either inhibited or enabled. In step 406, the selective backlighting service backlights only selected displayable area(s) of the display screen. For example, the selective backlighting service may communicate the area or areas to be backlighted or in which backlighting is non-enabled to the display control hardware. The display control hardware may then employ that information to inhibit or enable backlighting in selective area or areas of this display screen.

As can be appreciated by the foregoing, embodiments of the invention selectively control backlighting for portions of the display screen in which backlighting is not required. In most cases, backlighting is not necessary for areas in which there is no content to display (such as area 220 of FIG. 2). By turning off backlighting in areas of a display screen where no backlighting is required, battery power can be conserved, thereby extending the operational time of the portable electronic device.

While this invention has been described in terms of several preferred embodiments, there are alterations, permutations, and equivalents, which fall within the scope of this invention. It should also be noted that there are many alternative ways of implementing the methods and apparatuses of the present invention. Although various examples are provided herein, it is intended that these examples be illustrative and not limiting with respect to the invention.

What is claimed is:

1. A method for selectively controlling backlighting a display screen of a portable electronic device, comprising:
executing code to display first content in said display screen;
ascertaining at least a first portion of said display screen responsive to said first content, said first portion representing one of a backlight-enabled portion wherein backlighting is desirable and a backlight-nonenabled portion wherein backlighting is not desirable;
transmitting data pertaining said first portion of said display screen to display control circuitry; and
selectively backlighting, using said display control circuitry, said backlight-enabled portion of said display screen without backlighting said backlight-nonenabled portion while displaying said first content, both said backlight-enabled portion and said backlight nonenabled portion represent portions of said display screen for displaying contents.

2. The method of claim 1 wherein said first content represents an image.

3. The method of claim 1 wherein said first content represents text.

4. The method of claim 1 wherein said portable electronic device includes cellular telephony capability.

5. The method of claim 1 wherein said portable electronic device is a battery-powered computer.

6. The method of claim 1 wherein said ascertaining is performed by a selective backlighting service that is different from an application program executing said code to display said first content.

7. The method of claim 6 wherein said application program communicates with said selective backlighting service using at least an API (application programming interface).

8. The method of claim 1 wherein said data pertaining said first portion includes coordinate data.

9. The method of claim 1 wherein backlighting of said display screen is selectively controlled by said display control circuitry on a row-by-row basis.

10. The method of claim 1 wherein said backlighting of said display screen is selectively controlled by said display control circuitry on a pixel-by-pixel basis.

11. A method for selectively controlling backlighting a display screen of a portable electronic device, comprising:
executing code to display first content in said display screen;
ascertaining at least a first portion of said display screen responsive to said first content, said first portion representing one of a first backlight-enabled portion wherein backlighting is desirable and a first backlight-nonenabled portion wherein backlighting is not desirable;
transmitting data pertaining said first portion of said display screen to display control circuitry;
selectively backlighting, using said display control circuitry, said first backlight-enabled portion of said display screen without backlighting said first backlight-nonenabled portion while displaying said first content;
executing code to display second content in said display screen;
ascertaining at least a second portion of said display screen responsive to said second content, said second portion representing one of a second backlight-enabled portion wherein backlighting is desirable and a second backlight-nonenabled portion wherein backlighting is not desirable;
transmitting data pertaining said second portion of said display screen to said display control circuitry; and
selectively backlighting, using said display control circuitry, said second backlight-enabled portion of said display screen without backlighting said second backlight-nonenabled portion while displaying said second content, said second backlight-nonenabled portion spatially overlapping said first backlight-enabled portion that is backlighted when said first content is displayed.

12. The method of claim 11 wherein at least one of said first content and said second content represents an image.

13. The method of claim 11 wherein said portable electronic device includes cellular telephony capability.

14. The method of claim 11 wherein said portable electronic device is a battery-powered computer.

15. The method of claim 11 wherein said ascertaining of said first portion and said second portion is performed by a selective backlighting service that is different from an application program executing said code to display said first content and said second content.

16. The method of claim 15 wherein said application program communicates with said selective backlighting service using at least an API (application programming interface).

17. The method of claim 11 wherein said data pertaining to at least one of said first portion and said second portion includes coordinate data.

18. The method of claim 11 wherein backlighting of said display screen is selectively controlled by said display control circuitry on a row-by-row basis.

19. The method of claim 11 wherein said backlighting of said display screen is selectively controlled by said display control circuitry on a pixel-by-pixel basis.

20. A method for selectively controlling backlighting a display screen of a portable electronic device, comprising:
executing a first application program to display first content in said display screen;
receiving data pertaining said first content at a selective backlighting service, said selective backlighting service implemented in said portable electronic device;
ascertaining, using said selective backlighting service, at least a first portion of said display screen responsive to said first content, said first portion representing one of a backlight-enabled portion wherein backlighting is desirable and a backlight-nonenabled portion wherein backlighting is not desirable;
transmitting data pertaining said first portion of said display screen from said selective backlighting service to display control circuitry; and
selectively backlighting, using said display control circuitry, said backlight-enabled portion of said display screen without backlighting said backlight-nonenabled portion while displaying said first content, both said backlight-enabled portion and said backlight nonenabled portion represent portions of said display screen for displaying different contents at different times in said display screen.
